(19) United States
(12) Patent Application Publication
(10) Pub. No.: US 2010/0325433 A1
(43) Pub. Date: Dec. 23, 2010

(54) LOGIN SYSTEM

(75) Inventor: Michael Jörgensen, Ramlosa (SE)

Correspondence Address: VOLPE AND KOENIG, P.C., UNITED PLAZA, 30 SOUTH 17TH STREET, PHILADELPHIA, PA, 19103, US

(73) Assignee: SREG INTERNATIONAL AB, Helsingborg (SE)

(21) Appl. No.: 12/747,126

(22) PCT Filed: Dec. 11, 2008
(86) PCT No.: PCT/SE2008/000692

§ 371 Date: Sep. 3, 2010

Related U.S. Application Data
(60) Provisional application No. 61/013,031, filed on Dec. 12, 2007.

(30) Foreign Application Priority Data
Dec. 12, 2007 (SE) 0702768-3

(51) Int. Cl. H04L 9/32; G06F 21/00

(52) U.S. Cl. 713/168; 726/7

(57) ABSTRACT

A method for secure log on to a server is provided. The method includes: providing a first user name and a first password from a client to the server; determining if the first user name and first password correspond to a registered user; providing a first data set from the server to the client if the outcome of the determination step is positive; providing a second user name and a second password from the client to a trusted third party; determining if the second user name and second password correspond to a user registered at the trusted third party; providing the first data set from the client to the trusted third party if the outcome of the determination step is positive; providing the first data set from the trusted third party to the server; providing a second data set from the server to the trusted third party if the first data set received from the trusted third party corresponds to the first data set provided to the client; providing the second data set from the trusted third party to the client; providing the second data set from the client to the server; log on the client at the server if the second data set received from the client corresponds to the second data set provided to the trusted third party.

### TECHNICAL FIELD

The invention relates to a method and a system for providing secure log on to a server and a method and a system for providing secure provision of services on a server to a client.

### BACKGROUND OF THE INVENTION

Today, the Internet is commonly used for online banking services, shopping, making electronic transactions etc. This requires secure methods for performing remote identification of users of the services. Simply providing a user name and a password may not provide sufficient security since a malicious third party may easily identify itself as the user by either stealing the username or password by eaves-dropping or by using brute-force attacks.

To increase the security, many service providers requires the user to in addition to provide the ordinary authentication information, also provide a security token. The security token may be a smart card, a USB device etc. The security token may be fixed. However, there are also implementations using a dedicated device implementing an algorithm which generates a security token based on a seed. The seed may be a random number or a pseudo-random number such as the time value from a clock within the dedicated device. The service provider's (online bank, transaction company, electronic store etc.) server implements the same algorithm and may thus compare the received security token with the token generated by the server. If there is a match the user is authenticated for the requested service.

European patent publication A1-1 804 418 discloses authentication system, using a dynamic password telecommunication card embedded with a security algorithm in the SIM card of the user's mobile telephone to generate a momentarily changed password. The generated dynamic password is transmitted to a remote server running the same security algorithm generating the same dynamic password. If they match, access is granted for the user.

US patent publication 2004/0203595 A1 discloses an authentication system. The authentication system creates on demand a transient random pass code that is valid for a limited duration of time. The user may retrieve the password of the pass code via a cell telephone call to the authentication system before logging on to the system.

US patent publication 2007/0174080 A1 discloses a method by which customers of an institution, such as a bank, may register one or more of their landline telephone or mobile telephone numbers and associate the telephone numbers with their account and thereafter in conjunction with a remote transaction, use the registered telephone to call into a bank system or be called by a bank system, for verification, whereby the registered telephone becomes a security token that elevates the security of the transaction.

US patent publication 2007/0138261 A1 discloses a PIN server system interacting with a financial institution to authenticate a mobile phone and a user thereof. The PIN server provides to the mobile phone a PIN number to use in a financial transaction involving the financial institution, and also provides the one or more PIN numbers to the financial institutions in a manner that results in the one or more PIN numbers being associated with one or more accounts of the mobile phone user with the financial institution.

However, the prior art does not always provide a sufficiently high level of security while maintaining a low level of complexity for the user of the service. In the prior art, a separate device is often required for each service provider. This is cumbersome and since the security algorithms often are stored/coded in the device, the algorithms may be revealed through reverse-engineering or similar, thus compromising the security of the authentication methods.

Hackers and criminal organizations frequently find out new cunning methods for performing identity thefts and online frauds. As a result, security methods are constantly evolving to improve the security for the users. However, since a dedicated device is used in all prior art systems for generating security tokens, the device needs to be replaced each time an improved algorithm and method is developed.

Furthermore, the prior art systems all rely on third party solutions and prevent service providers (online bank or store etc.) to choose whatever authentication algorithms they find appropriate and alter these whenever they feel they need to.

Thus, there is a need for an improved method and system for secure log on to a server. There is also a need for an improved method and system for secure provision of services on a server to a client.

### SUMMARY OF THE INVENTION

According to a first aspect of the invention a method for secure log on to a server is provided. The method comprises: providing a first user name and a first password from a client to the server; determining if the first user name and first password correspond to a registered user; providing a first data set from the server to the client if the outcome of the determination step is positive; providing a second user name and a second password from the client to a trusted third party; determining if the second user name and second password correspond to a user registered at the trusted third party; providing the first dataset from the client to the trusted third party if the outcome of the determination step is positive; providing the first dataset from the trusted third party to the server; providing a second data set from the server to the trusted third party if the first data set received from the trusted third party corresponds to the first data set provided to the client; providing the second data set from the trusted third party to the client; providing the second data set from the client to the server; log on the client at the server if the second data set received from the client corresponds to the second data set provided to the trusted third party.

The method may comprise determining if the first user name and first password correspond to a user registered at a trusted third party.

According to the method the client may comprise a computer connected to the server and a mobile terminal connected to the trusted third party.

According to the method the client may comprise a mobile terminal connected to both the server and the trusted third party.

According to the method the mobile terminal may comprise an application program provided by the trusted third party for communicating with the trusted third party and/or the server.

According to the method the client and the trusted third party may communicate over an encrypted channel established by means of the application program provided by the trusted third party.

According to another aspect of the present invention, a system for secure log on to a server is provided. The system comprises: a client adapted to provide a first user name and a first password to the server; means for determining if the first user name and first password correspond to a registered user; means for providing a first data set from the server to the client if the outcome of the determination step is positive; means for providing a second user name and a second password from the client to the trusted third party; means for determining if the second user name and second password correspond to a user registered at a trusted third partymeans providing the first dataset from the client to the trusted third party if the outcome of the determination step is positive; means for providing the first dataset from the trusted third party to the server; means for providing a second data set from the server to the trusted third party if the first data set received from the trusted third party corresponds to the first data set provided to the client; means for providing the second data set from the trusted third party to the client; means for providing the second data set from the client to the server; means for logging on the client at the server if the second data set received from the client corresponds to the second data set provided to the trusted third party.

The system may comprise means for determining if the first user name and first password correspond to a user registered at a trusted third party.

The client may comprise a computer connectable to the server and a mobile terminal connectable to the trusted third party.

The client may comprise a mobile terminal connectable to both the server and the trusted third party.

The mobile terminal may comprises an application program provided by the trusted third party for communicating with the trusted third party and/or the server.

The client and the trusted third party may be adapted to communicate over an encrypted channel established by means of the application program provided by the trusted third party.

According to a third aspect of the present invention a method for secure provision of services on a server to a client is provided. The method comprises: providing a first data set from the server to the client; providing the first dataset from the client to a trusted third party; providing the first dataset from the trusted third party to the server if the client is a registered user of services at the trusted third party; providing a second data set from the server to the trusted third party if the first data set received from the trusted third party corresponds to the first data set provided to the client; providing the second data set from the trusted third party to the client; providing the second data set from the client to the server; providing one or more services on the server to the client if the second data set received from the client corresponds to the second data set provided to the trusted third party.

According to the method the client may comprise a computer connected to the server and a mobile terminal connected to the trusted third party.

According to the method the client may comprise a mobile terminal connected to both the server and the trusted third party.

According to the method the mobile terminal may comprise an application program provided by the trusted third party for communicating with the trusted third party and/or the server.

According to the method the client and the trusted third party may communicate over an encrypted channel established by means of the application program provided by the trusted third party.

According to the method the trusted third party and the server may communicate over an encrypted channel.

According to a fourth aspect of the present invention a system for secure provision of services on a server to a client is provided. The system comprises: means for providing a first data set from the server to the client; means for providing the first dataset from the client to a trusted third party; means for providing the first dataset from the trusted third party to the server if the client is a registered user of services at the trusted third party ; means for providing a second data set from the server to the trusted third party if the first data set received from the trusted third party corresponds to the first data set provided to the client; means for providing the second data set from the trusted third party to the client; means for providing the second data set from the client to the server; means for providing one or more services on the server to the client if the second data set received from the client corresponds to the second data set provided to the trusted third party.

The client may comprise a computer connectable to the server and a mobile terminal connectable to the trusted third party.

The client may comprise a mobile terminal connectable to both the server and the trusted third party.

The mobile terminal may comprise an application program provided by the trusted third party for communicating with the trusted third party and/or the server.

The client and the trusted third party may be adapted to communicate over an encrypted channel established by means of the application program provided by the trusted third party.

According to a fifth aspect of the present invention an alternative method for secure log on to a server is provided. The method comprises: providing a first user name from a client to the server; determining if the first user correspond to a user registered at a trusted third party; providing a second user name and a first password from the client to the trusted third party; determining if the second user name and first password correspond to a user registered at a trusted third party; providing a first data set from the server to the trusted third party if the user is registered at the trusted third party; providing the first data set from the trusted third party to the client; providing the first data set from the client to the server; log on the client at the server if the second data set received from the client corresponds to the second data set provided to the trusted third party.

According to the method the client may comprise a computer connected to the server and a mobile terminal connected to the trusted third party.

According to the method the client may comprise a mobile terminal connected to both the server and the trusted third party.

According to the method the mobile terminal may comprise an application program provided by the trusted third party for communicating with the trusted third party and/or the server.

According to the method the client and the trusted third party may communicate over an encrypted channel established by means of the application program provided by the trusted third party.

According to the method a second password may be provided from the client to the server and the determination step may comprise determining if the first user name and the second password correspond to a user registered at the trusted third party.

According to a fifth aspect of the present invention an alternative system for secure log on to a server is provided. The system comprises: a client adapted to provide a first user name to the server; means for determining if the first user name correspond to a registered user; means for providing a second user name and a first password from the client to the trusted third party; means for determining if the second user name and first password correspond to a user registered at a trusted third partymeans for providing a first data set from the server to the trusted third party if the user is registered at the trusted third party; means for providing the first data set from the trusted third party to the clientmeans for providing the first data set from the client to the server; means for logging on the client at the server if the first data set received from the client corresponds to the first data set provided to the trusted third party.

The system may comprise means for determining if the first user name and first password correspond to a user registered at a trusted third party.

The client may comprise a computer connectable to the server and a mobile terminal connectable to the trusted third party.

The client may comprise a mobile terminal connectable to both the server and the trusted third party.

The mobile terminal may comprise an application program provided by the trusted third party for communicating with the trusted third party and/or the server.

The client and the trusted third party may communicate over an encrypted channel established by means of the application program provided by the trusted third party.

The system may be adapted to provide a second password from the client to the server and the means for determining may be arranged to determine if the first user name and the second password correspond to a user registered at the trusted third party

### DRAWINGS

FIG. 1 illustrates a security system according to a first embodiment of the invention.

FIG. 2 is a flow chart of a method for secure log on to a server according to one embodiment of the invention.

FIG. 3 is a flow chart of a method for secure log on to a server according to an alternative embodiment of the invention.

FIG. 4 is a flow chart of a method for secure provision of services according to one embodiment of the invention.

### DETAILED DESCRIPTION OF THE EMBODIMENTS

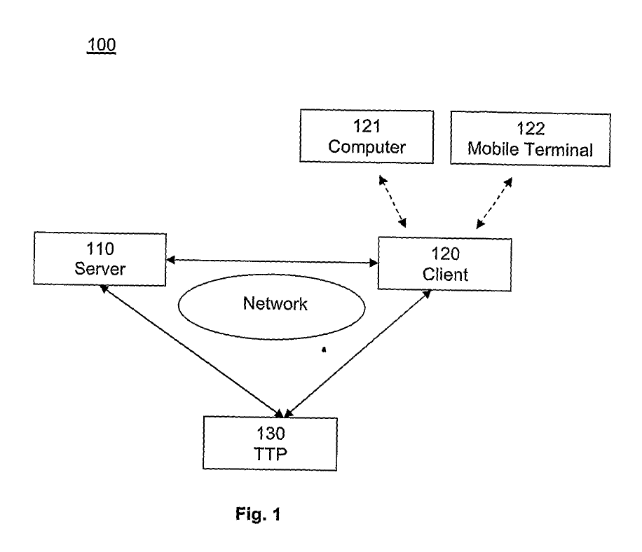

FIG. 1 illustrates a system according to a first aspect of the present invention. The system 100 comprises a server 110 which provides one or more services to a client 120 connected to the server 110. The services provided by the server 110 may be online bank service, electronic transactions, signing of electronic transactions, an online store etc.

According to a preferred embodiment of the present invention the client 120 comprises two or more entities such as a computer 121 connected to the server 110 via a network and a mobile terminal 122 such as a mobile phone, a PDA or any other device with wireless communications capabilities for connection to a trusted third party, which will be disclosed in more detail below. The client 120 may alternatively comprise only one entity which is capable of simultaneous communication with different network devices. The mobile terminal comprises presentation means, such as a speaker or a screen. The mobile terminal 122 may further comprise input means in the form of a keyboard, keypad or similar. The mobile terminal 122 may further comprise Internet communication capabilities (e.g. support Wireless Application Protocol (WAP) or other communication protocol.)

As mentioned above, the system also comprises a trusted third party server 130 communicating with both the server 110 and the client 120. Both the server 110 and the client 120 are registered at the trusted third party 130. The trusted third party 130 may comprise a database with registered servers (or service providers) and clients. Further, the trusted third party 130 is known and registered at the server 110. The trusted third party 130 is acts as a trusted party during authentication, providing an increased level of security without adding complexity for the neither the service provider nor the user of the services. The trusted third party 130 may further act as a trusted party for any number of service providers. The details, advantages and uses of the trusted third party 130 will be clear from the following description.

The server 110 and the trusted third party 130 comprise means for connecting to a network and communicate remotely with each other, e.g. network cards, wired or wireless and may be connected to the network through routers, firewalls or through other conventional network infrastructure.

The server 110 and the trusted third party 130 may communicate via a common network such as the Internet or any other Wide Area Network (WAN) or Local Area Network (LAN). The server 110 and the trusted third party 130 may communicate via the Internet over an encrypted channel such as a Secure Sockets Layer (SSL) or a Transport Layer Security (TLS) connection or similar. The client mobile terminal 122 may communicate with the trusted third party 130 via any network, e.g. via a Wireless Access Point connected to the Internet, via a cellular network supporting General Packet Radio Service (GPRS), 3G operation or similar.

A user at the client 120 who wants to gain access to one or more services at the server 110 as disclosed above provides a first user name and a first password to the server 110.

The first user name and the first password may be provided to the server 110 by conventional methods, i.e. entering the first user name and the first password via a web interface provided by the server 110 to a client computer 121 or client mobile terminal 122. The first user name and the first password may also be provided using a dedicated application, e.g. a Java-application, a Java-applet or similar running on the client computer 121. Preferably, the first user name and the first password are encrypted before being provided to the server 110. The encryption may be accomplished by methods well-known in the art, e.g. asymmetric key pairs, electronic certificates etc.

After receiving the user name and password from the user at the client 120 the server 110 determines if the user name and password correspond to a user who is registered at the server 110. This may be accomplished by the server 110 searching for a matching user name in a local or remote database comprising information on registered users of the server 110. If the password provided by the user matches the password in the database entry corresponding to the provided user name, the mobile terminal 122 is authenticated for use with the server 110. Further methods for performing user authentication are well-known in the art of internet and network technology and will not be further detailed in this description. If the user is registered at the server 110, an encrypted communication channel is established between the server 110 and the client computer 121.

The server 110 then contacts the trusted third party 130, preferably via an encrypted communication channel in order to determine if the user is also a registered user at the trusted third party 130. This may be accomplished by the server 110 transmitting a message to the trusted third party 130 via the encrypted communication channel, the message comprising the identity of the user and further information required for identifying the user at the trusted third party 130.

The trusted third party 130 may determine if the user is registered for the trusted third party 130 by searching for the identification information received by the server 110 in a local or remote database comprising entries of users registered for services at the trusted third party 130.

If the trusted third party 130 acknowledges that the user is a registered user the server 110 provides a first data set from the server 110 to the client 120. This may preferably be done by transmitting a first data set, i.e. a first code, from the server 110 to the client 120 via the established encrypted communication channel and displaying the code on a display to the user at the client 120. The first data set may be one key of a key-pair generated by any well-known key-generating algorithms, symmetric-key algorithms (DES, AES) or public-key algorithms (RSA). The first data set may also be a random or pseudo-random number or character combination.

The user at the client 120 then uses the mobile terminal 122 in the client 120 for providing a second user name and a second password from the client 120 to the trusted third party 130.

The second user name and second password is preferably provided to the trusted third party 130 via an encrypted channel. The second user name and second password may be entered via a web interface accessed over the Internet. Preferably, the access to the trusted third party 130 is provided via a dedicated client application in the mobile terminal 122. The client application may be a Java application or any other application type suitable for being executed on a mobile terminal 122. The client application may further be authorized for use with the trusted third party 130 by the provider of the trusted third party 130. The client application provides the user of the mobile terminal 122 with an interface for providing the second user name and password. The client application further establishes an encrypted channel between the mobile terminal 122 and the trusted third party 130.

The communication between the mobile terminal 122 and the trusted third party 130 may be initiated by the user at the mobile terminal 122 or by the trusted third party 130. In the former case the client 120 application may establish an encrypted channel to the trusted third party and transfer the second user name and second password. In the latter case the server 110 may instruct the trusted third party 130 to establish an encrypted channel to the mobile terminal 122 and provide information to the user thereof to input the second user name and second password. Alternatively may the server instruct the trusted third party 130 to establish an encrypted channel to the mobile terminal 122 and without the second user name and second password provide access to the services at the trusted third party, in this case, i.e. as will be disclosed in more detail below, making it possible for the user at the mobile terminal 122 to provide the first dataset received from the server 110 to the trusted third party via the encrypted data channel. This results in a slightly lower security level but if the mobile terminal is registered with the trusted third party prior to establishing the encrypted channel above, the security level may be acceptable for many applications. A combination of the different initiation possibilities may also be utilized. For example may a user at the client 120 be provided only with limited services in case the initiation is performed using a lower security level, i.e. the user may e.g. view data at the trusted third party 130 or the server 110, but not alter the data until a higher security level is instituted e.g. by the provision of a second username and password.

Preferably the client application comprises a unique code associated with the second user name and the second password. The client application and the unique code is preferably provided by the trusted third party 130 to the mobile terminal 122 during registration of the mobile terminal 122 for use with the trusted third party 130. The unique code may be stored in for example a database of the trusted third party 130 along with the user name, the password and further user information. The client 120 application may provide the unique code to the trusted third party 130 along with the second user name and the second password. This enables the trusted third party 130 to compare the received unique code to the stored unique code. The mobile terminal may then be authenticated for use with the trusted third party 130 only if the received unique code matches the stored unique code. This provides an additional level of security since only the mobile terminal 122 used during registration with at trusted third party 130 is authorized for the trusted third party 130.

The trusted third party 130 then determines if the second user name and second password correspond to a user registered at a trusted third party. If a unique code is also used according to the paragraph above, the trusted third party 130 may further determine the received unique code matches a stored unique code as described in the previous paragraph. The determination may be accomplished by the trusted third party 130 searching for a matching entry in a local or remote database comprising information on registered users of the trusted third party 130. If the mobile terminal 122 is found in the database entry, the mobile terminal 122 is authenticated for use with the trusted third party 130.

If the user is authenticated at the trusted third party 130 the trusted third party 130 acknowledges this to the client 120, wherein the client 120 provides the first dataset received from the server 110 to the trusted third party via the encrypted data channel established as disclosed above. The first dataset may be provided to the trusted third party 130 using a conventional web-interface or using a dedicated application as described above.

Upon receiving the first data set from the client 120 the trusted third party 130 provides the first data set to the server 110 via the encrypted communication channel established as disclosed above.

The server 110 then compares the received first data set with the data set provided to the client 120. This comparison may be accomplished by a control unit in the server 110, the control unit comprising a data memory area where the first data set may be stored. The control unit may then compare the stored first data set to the received first data set.

The first data data set may be valid for a set time interval, e.g. 30 seconds from the provision of the first data set from the server 110 to the client 120. However, any other appropriate time interval may also be used. If the server 110 receives the first data set after the expiry of the time interval the server 110 will not accept the first data set.

If the first data set received from the trusted third party 130 corresponds to the first data set provided to the client 120, the server 110 provides a second data set, i.e. a second code, from the server 110 to the trusted third party 130.

The second data set is transmitted to the trusted third party 130 via the encrypted channel disclosed above. It may be transmitted as a message in one or more data packets by methods well-known in the art. The second data set may be generated by similar methods as the first data set. I.e., the second data set may be the key corresponding to the first data set key of a key-pairs disclosed above. The second data set may also be a random or pseudo-random number or character combination.

Upon receiving the second data set the trusted third party 130 provides the second data set to the client 120 via the encrypted channel, wherein the second data set is displayed on the display on the mobile terminal 122. The second data set may be provided to the client 120 simply by forwarding the message received from the server 110, or by extracting the second data set from the message, generate a new message comprising the extracted second data set and transmit the message via the encrypted channel to the client 120.

The user at the client 120 may then provide the second data set to the server 110 via the encrypted communication channel established as disclosed above. The user may provide the second data set to the server 110 by entering the second data set via a web interface provided by the server 110. It may also be provided using a dedicated application, e.g. a Java-application, a Java-applet or similar.

The server 110 then compares the received second data set with the data set provided to the trusted third party 130. This comparison may be accomplished by a control unit in the server 110, the control unit comprising a data memory area where the second data set may be stored before being transmitted to the trusted third party 130. The control unit compares the stored second data set to the received second data. The client 120 is logged on for additional services at the server 110, not accessible by merely providing a first user name and first password, if the second data set received from the client 120 corresponds to the second data set provided to the trusted third party (stored in the control unit).

Similar to the first data set, also the second data set may be valid for a set time interval, e.g. 30 seconds from the provision of the second data set from the server 110 to the trusted third party 130. However, any other appropriate time interval may also be used. If the server 110 receives the second data set after the expiry of the time interval the server 110 will not accept the second data set and the client 120 is not logged on at the server 110.

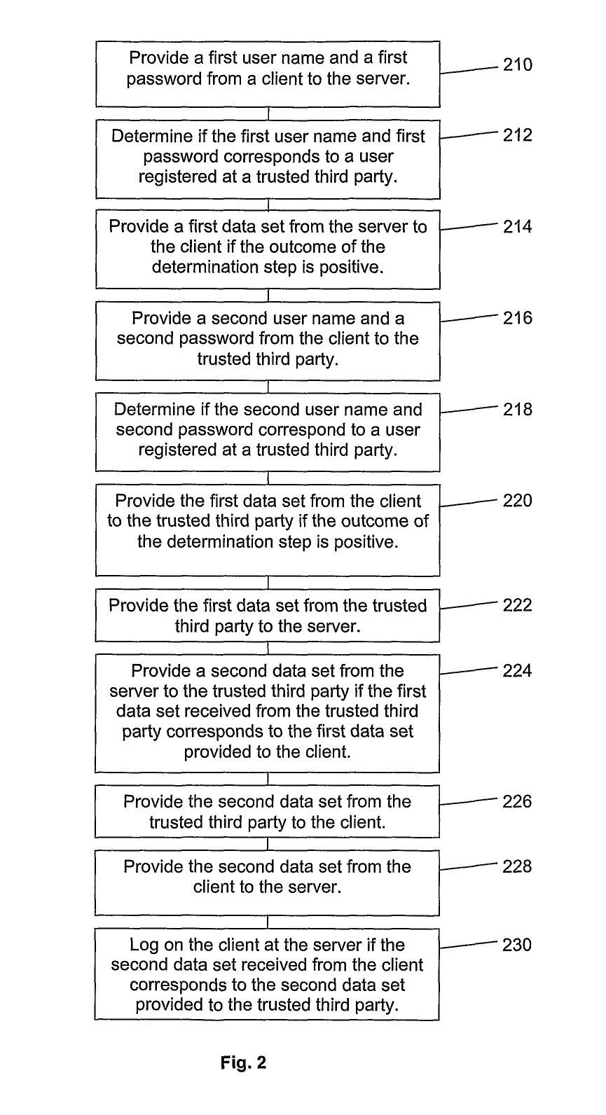

FIG. 2 is a flow chart of a method for secure log on to a server according to one embodiment of the invention. A first user name and a first password is provided 210 from a client to the server. According to another embodiment the client may comprise a computer connected to the server and a mobile terminal connected to a trusted third party. According to a further embodiment the client comprises a mobile terminal connected to both the server and the trusted third party. The mobile terminal may comprise an application program provided by the trusted third party for communicating with the trusted third party and/or the server. The application program may establish an encrypted channel between the client and the trusted third party and/or the server

According to the method, it is further determined 212 if the first user name and first password correspond to a user registered at the trusted third party. If the determination is positive, a first data set is provided 214 from the server to the client. Preferably, the trusted third party and the server communicates over an encrypted channel.

A second user name and a second password is provided 216 from the client to the trusted third party. It is further determined 218 if the second user name and second password correspond to a user registered at a trusted third party. If the determination is positive, the first dataset is provided 220 from the client to the trusted third party. Preferably, the client and the trusted third party communicates over an encrypted channel.

Further, the first dataset is provided 222 from the trusted third party to the server. If the first data set received from the trusted third party corresponds to the first data set provided to the client, a second data set is provided 224 from the server to the trusted third party to the client.

The second data set is provided 226 from the trusted third party to the client and in turn provided 228 from the client to the server. If the second data set received from the client corresponds to the second data set provided to the trusted third party, the client is logged 230 on at the server.

According to a second embodiment, a simplified method and system for providing secure log on to a server 110 is provided. This embodiment is also described with reference to FIG. 1 which illustrates a system 100 comprising a server 110 which provides one or more services to a client 120 connected to the server 110. The services may be online bank service, electronic transactions, signing of electronic transactions, an online store etc.

According to a preferred embodiment of the present invention the client 120 comprises two or more entities such as a computer 121 connected to the server 110 via a network and a mobile terminal 122 such as a mobile phone, a PDA or any other device with wireless communications capabilities. The client 120 may alternatively comprise only one entity which is capable of simultaneous communication with different network devices. The mobile terminal 122 comprises presentation means, such as a speaker or a screen. The mobile terminal 122 may further comprise input means in the form of a keyboard, keypad or similar. The mobile terminal 122 may further comprise Internet communication capabilities (e.g. support Wireless Application Protocol (WAP) or other communication protocol.)

The system also comprises a trusted third party server 130 communicating with both the server 110 and the client 120. Both the server 110 and the client 120 are registered at the trusted third party 130. The trusted third party 130 may comprise a database with registered servers (or service providers) and clients 120. Further, the trusted third party 130 is known and registered at the server 110. The trusted third party 130 is provided to act as a trusted party 130 during authentication, providing an increased level of security without adding complexity for the neither the service provider nor the user of the services. The trusted third party 130 may further act as a trusted party 130 for any number of service providers. The details and uses of the trusted third party 130 will be clear from the following description.

The server 110 and the trusted third party 130 comprise ordinary means for connecting to a network and communicate remotely with each other, e.g. network cards, wired or wireless and may be connected to the network through routers, firewalls or through other conventional network infrastructure.

The server 110 and trusted third party 130 may communicate via a common network such as the Internet or any other Wide Area Network (WAN) or Local Area Network (LAN). The server 110 and trusted third party 130 may communicate via the Internet over an encrypted channel such as a Secure Sockets Layer (SSL) or a Transport Layer Security (TLS) connection or similar. The server 110 and the client 120 computer may communicate via a common network such as the Internet or any other Wide Area Network (WAN) or Local Area Network (LAN). The client mobile terminal 122 may communicate with the trusted third party 130 via any network, e.g. via a Wireless Access Point connected to the Internet, via a cellular network supporting General Packet Radio Service (GPRS), 3G operation or similar.

A user at the client 120 who wants to gain access to one or more services at the server 110 as disclosed above provides a first user name. The first user name may be any user name registered for use with the server 110 and may be in the form of a social security number or similar. Optionally, the user may provide also a first password to the server 110.

The first user name may be provided to the server 110 by e.g. entering the first user name via a web interface provided by the server 110. It may also be provided using a dedicated application, e.g. a Java-application, a Java-applet or similar running on the client 120 computer. Preferably, the first user name is encrypted before being provided to the server 110. The encryption may be accomplished by methods well-known in the art, e.g. asymmetric key pairs, electronic certificates etc.

After receiving the user name and password from the user at the client 120 the server 110 determines if the user name correspond to a user who is registered at the server 110. This may be accomplished by the server 110 searching for a matching user name in a local or remote database comprising information on registered users of the server 110. Further methods for performing user authentication are well-known in the art of Internet and network technology and will not be further detailed in this description. If the user is registered at the server 110, an encrypted communication channel is established between the server 110 and the client 120 computer.

The server 110 then contacts the trusted third party 130, preferably via an encrypted communication channel in order to determine if the user is also a registered user at the trusted third party 130. This may be accomplished by the server 110 transmitting a message to the trusted third party 130 via the encrypted communication channel, the message comprising the identity of the user and further information required for identifying the user at the trusted third party 130.

The trusted third party 130 may determine if the user is registered for the trusted third party 130 by searching for the identification information received by the server 110 in a remote or local user database comprising entries of users registered for at the trusted third party 130.

If the trusted third party 130 acknowledges that the user is a registered user the server 110 provides a first data set from the server 110 to the trusted third party 130. This may preferably be done by transmitting a first data set, i.e. a first code, from the server 110 to the trusted third party 130 via the established encrypted communication channel. The first data set may be one key of a key-pair generated by any well-known key-generating algorithms, symmetric-key algorithms (DES, AES) or public-key algorithms (RSA). The first data set may also be a random or pseudo-random number or character combination.

The user at the client 120 then uses a mobile terminal 122 for providing a second user name and a second (or first) password from the client 120 to the trusted third party 130. The second user name and second password is preferably provided to the trusted third party 130 via an encrypted channel. The second user name and second password may be entered via a web interface accessed over the Internet. Preferably, the access to the trusted third party 130 is provided via a dedicated client 120 application in the mobile terminal 122. The client 120 application may be a Java application or any other application type suitable for being executed on a mobile terminal 122. The client 120 application may further be authorized for use with the trusted third party 130 by the provider of the trusted third party 130. The client 120 application provides the user of the mobile terminal 122 with an interface for providing the user name and password. The client 120 application further establishes an encrypted channel between the mobile terminal 122 and the trusted third party 130.

The communication between the mobile terminal 122 and the trusted third party 130 may be initiated by the user at the mobile terminal 122 or by the trusted third party 130. In the former case the client 120 application may establish an encrypted channel to the trusted third party and transfer the second user name and second password. In the latter case the server 110 may instruct the trusted third party 130 to establish an encrypted channel to the mobile terminal 122 and provide information to the user thereof to input the second user name and second password. Alternatively may the server instruct the trusted third party 130 to establish an encrypted channel to the mobile terminal 122 and without the second user name and second password provide access to the services at the trusted third party, in this case, i.e. as will be disclosed in more detail below, making it possible for the user at the mobile terminal 122 to provide the first dataset received from the server 110 to the trusted third party via the encrypted data channel. This results in a slightly lower security level but if the mobile terminal is registered with the trusted third party prior to establishing the encrypted channel above, the security level may be acceptable for many applications. A combination of the different initiation possibilities may also be utilized. For example may a user at the client 120 be provided only with limited services in case the initiation is performed using a lower security level, i.e. the user may e.g. view data at the trusted third party 130 or the server 110, but not alter the data until a higher security level is instituted e.g. by the provision of a second username and password.

Preferably the client 120 application comprises a unique code associated with the second user name and the second password. The client 120 application and the unique code is preferably provided by the trusted third party 130 to the mobile terminal 122 during registration of the mobile terminal 122 for use with the trusted third party 130. The unique code is also stored in for example a database of the trusted third party 130 along with the user name, the password and further user information. The client 120 application may provide the unique code to the trusted third party 130 along with the second user name and the second password. This enables the trusted third party 130 to compare the received unique code to the stored unique code. The mobile terminal 122 may then be authenticated for use with the trusted third party 130 only if the received unique code matches the stored unique code. This provides an additional level of security since only the mobile terminal 122 used during registration with the trusted third party 130 is authorized for the trusted third party 130.

The trusted third party 130 then determines if the second user name and second password correspond to a user registered at a trusted third party 130. If a unique code is also used according to the above, the trusted third party 130 may further determine if the received unique code matches a stored unique code as described above. The determination may be accomplished by the trusted third party 130 searching for a matching entry in a local or remote database comprising information on registered users of the trusted third party 130. If the mobile terminal 122 is found in the database entry, the mobile terminal 122 is authenticated for use with the trusted third party 130.

If the user is authenticated at the trusted third party 130 the trusted third party 130 provides the first data set to the client 120 via the encrypted channel, wherein the first data set is displayed on the display on the mobile terminal 122. The first data set may be provided to the client 120 simply by forwarding the message received from the server 110, or by extracting the first data set from the message, generate a new message comprising the extracted first data set and transmit the message via the encrypted channel to the client 120.

The user at the client 120 may then provide the first data set to the server 110 via the encrypted communication channel established as disclosed above. The user may provide the first data set to the server 110 by entering the first data set via a web interface provided by a web-service of the server 110. The first data set may also be provided using a dedicated application, e.g. a Java-application, a Java-applet or similar.

The server 110 then compares the received first data set with the data set provided to the trusted third party 130. This comparison may be accomplished by a control unit in the server 110, the control unit comprising a data memory area where the first data set may be stored before being transmitted to the trusted third party 130. The control unit compares the stored first data set to the received first data set. The client 120 is logged on for additional services at the server 110, not accessible by merely providing a first user name and first password, if the first data set received from the client 120 corresponds to the first data set provided to the trusted third party 130 (stored in the control unit).

The first data data set may be valid for a set time interval, e.g. 30 seconds from the provision of the second data set from the server 110 to the trusted third party 130. However, any other appropriate time interval may also be used. If the server 110 receives the first data set after the expiry of the time interval the server 110 will not accept the first data set and the client 120 is not logged on at the server 110.

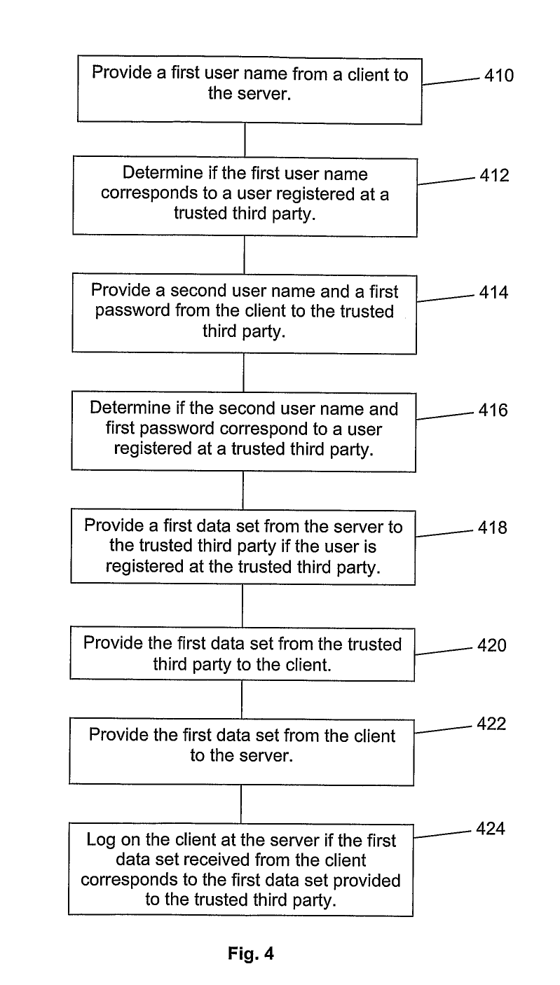

FIG. 4 is a flow chart of a method for secure log on to a server according to an alternative embodiment of the invention. A first user name is provided 410 from a client to the server. Optionally, a second password is provided from the client to the server in addition to the first user name. According to another embodiment the client may comprise a computer connected to the server and a mobile terminal connected to a trusted third party. According to a further embodiment the client comprises a mobile terminal connected to both the server and the trusted third party. The mobile terminal may comprise an application program provided by the trusted third party for communicating with the trusted third party and/or the server. The application program may establish an encrypted channel between the client and the trusted third party and/or the server.

According to the method, it is further determined 412 if the first user name and (optionally) the second password correspond to a user registered at the trusted third party. Further, a second user name and a first password is provided 414 from the client to the trusted third party. It is further determined 416 if the second user name and second password correspond to a user registered at a trusted third party. If the determination is positive, a first data set is provided 418 from the server to the trusted third party. Preferably, the server and the trusted third party communicates over an encrypted channel.

Further, the first dataset is provided 420 from the trusted third party to the client and in turn the first data set is provided 422 from the client to the server. If the first data set received from the client corresponds to the first data set provided to the trusted third party, the client is logged on 424 for additional services at the server.

According to a second aspect of the present invention, a system and method for secure provision of services on a server 110 to a client 120 is provided. This aspect and embodiment is also described with reference to FIG. 1 which illustrates a system 100 comprising a server 110 which provides one or more services to a client 120 connected to the server 110. The services may be online bank service, electronic transactions, signing of electronic transactions, an online store etc.

According to a preferred embodiment of the present invention the client 120 comprises two or more entities such as a computer 121 connected to the server 110 via a network and a mobile terminal 122 such as a mobile phone, a PDA or any other device with wireless communications capabilities. The client 120 may alternatively comprise only one entity which is capable of simultaneous communication with different network devices. The mobile terminal 122 comprises presentation means, such as a speaker or a screen The mobile terminal 122 may further comprise input means in the form of a keyboard, keypad or similar. The mobile terminal 122 may further comprise Internet communication capabilities (e.g. support Wireless Application Protocol (WAP) or other communication protocol.)

The server 110, trusted third party 130 and the client 120 communicate via one or more common networks. The server 110 and the trusted third party 130 comprise means for connecting to a network and communicate remotely with each other, e.g. network cards, wired or wireless. The network may be the Internet. The client mobile terminal 122 may communicate with the trusted third party 130 via any network, e.g. connecting to a wireless access point connected to the Internet or communicate via GPRS with the Internet etc.

The server 110 and the trusted third party 130 comprise means for connecting to a network and communicate remotely with each other, e.g. network cards, wired or wireless and may be connected to the network through routers, firewalls or through other conventional network infrastructure.

The server 110 and trusted third party 130 may communicate via a common network such as the Internet or any other Wide Area Network (WAN) or Local Area Network (LAN). The server 110 and trusted third party 130 may communicate via the Internet over an encrypted channel such as a Secure Sockets Layer (SSL) or a Transport Layer Security (TLS) connection or similar. The client 120 mobile terminal may communicate with the trusted third party 130 via any network, e.g. via a Wireless Access Point connected to the Internet, via a cellular network supporting General Packet Radio Service (GPRS), 3G operation or similar.

A user at the client 120 who wants to gain access to one or more services mentioned above is provided with a first data set from the server 110. This may preferably be done by transmitting a first data set, i.e. a first code, from the server 110 to the client 120 and displaying the code on a display at the client 120. The code may also be provided to the client as audio data (for the hearing-impaired) or in any other form. The first data set may be one key of a key-pair generated by any well-known key-generating algorithms, symmetric-key algorithms (DES, AES) or public-key algorithms (RSA). The first data set may also be a random or pseudo-random number or character combination.

The user at the client 120 then uses a mobile terminal 122 for providing the first data set from the client 120 to the trusted third party 130. The first data set is preferably provided to the trusted third party 130 via an encrypted channel. The first data set may be entered via a web interface over the Internet. Preferably, the access to the trusted third party 130 is provided via a dedicated client 120 application in the mobile terminal 122. The client 120 application may be a Java application or any other application type suitable for being executed on a mobile terminal 122. The client 120 application may further be authorized for use with the trusted third party 130 by the provider of the trusted third party 130. The client 120 application provides the user of the mobile terminal 122 with an interface for providing the user name and password. The client 120 application further establishes an encrypted channel between the mobile terminal 122 and the trusted third party 130.

The communication between the mobile terminal 122 and the trusted third party 130 may be initiated by the user at the mobile terminal 122 or by the trusted third party 130. In the former case the client 120 application may establish an encrypted channel to the trusted third party and transfer the second user name and second password. In the latter case the server 110 may instruct the trusted third party 130 to establish an encrypted channel to the mobile terminal 122 and provide information to the user thereof to input the second user name and second password. Alternatively may the server instruct the trusted third party 130 to establish an encrypted channel to the mobile terminal 122 and without the second user name and second password provide access to the services at the trusted third party, in this case, i.e. as will be disclosed in more detail below, making it possible for the user at the mobile terminal 122 to provide the first dataset received from the server 110 to the trusted third party via the encrypted data channel. This results in a slightly lower security level but if the mobile terminal is registered with the trusted third party prior to establishing the encrypted channel above, the security level may be acceptable for many applications.

Preferably the client 120 application comprises a unique code associated with the second user name and the second password. The client 120 application and the unique code is preferably provided by the trusted third party 130 to the mobile terminal 122 during registration of the mobile terminal 122 for use with the trusted third party 130. The unique code is also stored in for example a database of the trusted third party 130 along with the user name, the password and further user information. The client 120 application may provide the unique code to the trusted third party 130 along with the second user name and the second password. This enables the trusted third party 130 to compare the received unique code to the stored unique code. The mobile terminal 122 may then be authenticated for use with the trusted third party 130 only if the received unique code matches the stored unique code. This provides an additional level of security since only the mobile terminal 122 used during registration with at trusted third party 130 is authorized for the trusted third party 130.

The trusted third party then determines if the client 120, e.g. the mobile terminal 122, is registered and authorized as a user of the trusted third party 130. This may be accomplished by the trusted third party 130 searching for a matching entry in a local or remote database comprising information on registered users of the trusted third party 130. If the mobile terminal 122 is found in the database entry, the mobile terminal 122 is authenticated for use with the trusted third party 130.

If the user, i.e. the mobile terminal 122 is registered and authenticated at the trusted third party 130, the trusted third party 130 provides the first dataset to the server 110. Preferably, the first data set is provided via an encrypted communication channel between the trusted third party 130 and the server 110. It may be transmitted as a message in one or more data packets by methods well-known in the art.

The server 110 then compares the received first data set with the data set provided to the client 120. This comparison may be accomplished by a control unit in the server 110, the control unit comprising a data memory area where the first data set may be stored. The control unit may then compare the stored first data set to the received first data set.

The first data set may be valid for a set time interval, e.g. 30 seconds from the provision of the first data set from the server 110 to the client 120. However, any other appropriate time interval may also be used. If the server 110 receives the first data set after the expiry of the time interval the server 110 will not accept the first data set.

If the first data set received from the trusted third party 130 corresponds to the first data set provided to the client 120, the server 110 provides a second data set, i.e. a second code, from the server 110 to the trusted third party 130.

The second data set is transmitted to the trusted third party 130 via the encrypted channel disclosed above. It may be transmitted as a message in one or more data packets by methods well-known in the art. The second data set may be generated by similar methods as the first data set. I.e., the second data set may be the key corresponding to the first data set key of a key-pair consisting. The second data set may also be a random or pseudo-random number or character combination.

Upon receiving the second data set the trusted third party 130 provides the second data set to the client 120 via the encrypted channel, wherein the second data set is displayed on the display on the mobile terminal 122. The second data set may be provided to the client 120 simply by forwarding the message received from the server 110, or by extracting the second data set from the message transmitted from the server 110, generating a new message comprising the extracted second data set and transmit the message via the encrypted channel to the client 120.

The user at the client 120 may then provide the second data set to the server 110 via the encrypted communication channel established as disclosed above. The user may provide the second data set to the server 110 by entering the second data set via a web interface provided by the server 110. It may also be provided using a dedicated application, e.g. a Java-application, a Java-applet or similar.

The server 110 then compares the received second data set with the data set provided to the trusted third party 130. This comparison may be accomplished by a control unit in the server 110, the control unit comprising a data memory area where the first data set may be stored before being transmitted to the user. The control unit compares the stored first data set to the received first data and set provides said one or more services to the client 120 if the second data set received from the client 120 corresponds to the second data set provided to the trusted third party 130 (stored in the control unit).

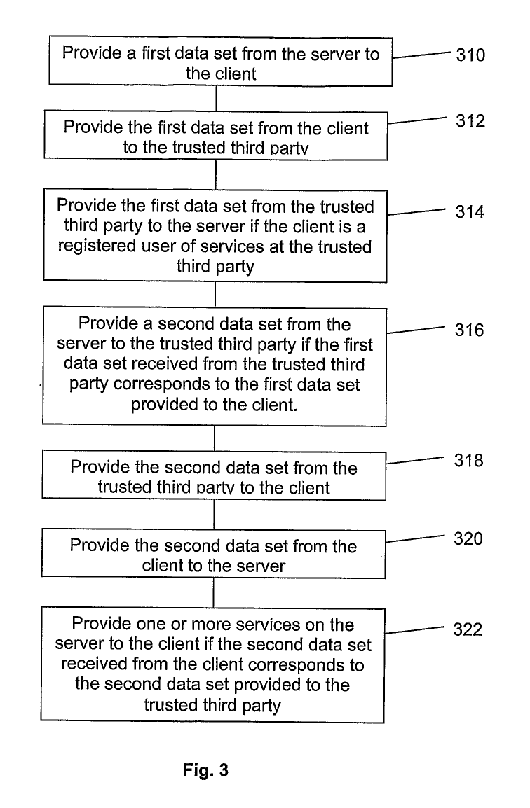

FIG. 3 is a flow chart of a method for secure provision of services on a server to a client according to one embodiment of the invention. A first data set is provided 310 from a server to a client which first data set in turn is provided 312 to a trusted third party. According to one embodiment the client may comprise a computer connected to the server and a mobile terminal connected to a trusted third party. According to a further embodiment the client comprises a mobile terminal connected to both the server and the trusted third party. The mobile terminal may comprise an application program provided by the trusted third party for communicating with the trusted third party and/or the server. The application program may establish an encrypted channel between the client and the trusted third party and/or the server.

According to the method, the first data set is further provided 314 from the trusted third party to the server if the client is a registered user of services at the trusted third party. If the first data set received from the trusted third party corresponds to the first data set provided to the client, a second data set is provided 316 from the server to the trusted third party.

The second data set is provided 318 from the trusted third party to the client and in turn provided 320 from the client to the server. If the second data set received from the client corresponds to the second data set provided to the trusted third party, one or more services on the server are provided 322 to the client.

In an alternative embodiment the client 120 may comprise only one entity which is capable of simultaneous communication with different network devices. Such an entity may be a mobile terminal 122 comprising presentation means, such as a speaker or a screen. The mobile terminal 122 further comprises input means in the form of a keyboard, keypad or similar. Such a client mobile terminal 122 may be used both to receive the services provided by the server 110 and to communicate with the trusted third party 130. The client mobile terminal 122 may communicate with the trusted third party 130 via any network, e.g. via a Wireless Access Point connected to the Internet, via a cellular network supporting General Packet Radio Service (GPRS), 3G operation or similar.

1. A method for secure log on to a server, comprising: providing a first user name and a first password from a client to the server;
determining if the first user name and first password correspond to a registered user;
providing a first data set from the server to the client if the outcome of the determination step is positive;
providing a second user name and a second password from the client to a trusted third party;
determining if the second user name and second password correspond to a user registered at the trusted third party;
providing the first data set from the client to the trusted third party if the outcome of the determination step is positive;
providing the first data set from the trusted third party to the server;
providing a second data set from the server to the trusted third party if the first data set received from the trusted third party corresponds to the first data set provided to the client;
providing the second data set from the trusted third party to the client;
providing the second data set from the client to the server; and
logging on the client at the server if the second data set received from the client corresponds to the second data set provided to the trusted third party.

2. The method according to claim 1 comprising determining if the first user name and first password correspond to a user registered at the trusted third party;

3. The method according to claim 1, wherein the client comprises a computer connected to the server and a mobile terminal connected to the trusted third party.

4. The method according to claim 1, wherein the client comprises a mobile terminal connected to both the server and the trusted third party.

5. The method according to claim 3, wherein the mobile terminal comprises an application program provided by the trusted third party for communicating with the trusted third party and/or the server.

6. The method according to claim 1, wherein the client and the trusted third party communicates over an encrypted channel established by an application program provided by the trusted third party.

7. A system for secure log on to a server, comprising: a client adapted to provide a first user name and a first password to the server;
device configured to determine if the first user name and first password correspond to a registered user;
device configured to provide a first data set from the server to the client if the outcome of the determination step is positive;
device configured to provide a second user name and a second password from the client to the trusted third party;
device configured to determine if the second user name and second password correspond to a user registered at a trusted third party;
device configured to provide the first data set from the client to the trusted third party if the outcome of the determination step is positive;
device configured to provide the first data set from the trusted third party to the server;
device configured to provide a second data set from the server to the trusted third party if the first data set received from the trusted third party corresponds to the first data set provided to the client;
device configured to provide the second data set from the trusted third party to the client;
device configured to provide the second data set from the client to the server; and
device configured to log on the client at the server if the second data set received from the client corresponds to the second data set provided to the trusted third party.

8. The system according to claim 7 comprising device configured to determine if the first user name and first password correspond to a user registered at the trusted third party.

9. The system according to claim 7, wherein the client comprises a computer connectable to the server and a mobile terminal connectable to the trusted third party.

10. The system according to claim 7, wherein the client comprises a mobile terminal connectable to both the server and the trusted third party.

11. The system according to claim 9, wherein the mobile terminal comprises an application program provided by the trusted third party for communicating with the trusted third party and/or the server.

12. The system according to claim 7, wherein the client and the trusted third party are adapted to communicate over an encrypted channel established by an application program provided by the trusted third party.

13. A method for secure provision of services on a server to a client comprising:
providing a first data set from the server to the client;
providing the first data set from the client to a trusted third party;
providing the first data set from the trusted third party to the server if the client is a registered user of services at the trusted third party;
providing a second data set from the server to the trusted third party if the first data set received from the trusted third party corresponds to the first data set provided to the client;
providing the second data set from the trusted third party to the client;
providing the second data set from the client to the server; and
providing one or more services on the server to the client if the second data set received from the client corresponds to the second data set provided to the trusted third party.

14. The method according to claim 13, wherein the client comprises a computer connected to the server and a mobile terminal connected to the trusted third party.

15. The method according to claim 13, wherein the client comprises a mobile terminal connected to both the server and the trusted third party.

16. The method according to claim 14, wherein the mobile terminal comprises an application program provided by the trusted third party for communicating with the trusted third party and/or the server.

17. The method according to claim 13, wherein the client and the trusted third party communicates over an encrypted channel established by means of an application program provided by the trusted third party.

18. A system for secure provision of services on a server to a client, comprising:
device configured to provide a first data set from the server to the client;
device configured to provide the first data set from the client to a trusted third party;
device configured to provide the first data set from the trusted third party to the server if the client is a registered user of services at the trusted third party;
device configured to provide a second data set from the server to the trusted third party if the first data set received from the trusted third party corresponds to the first data set provided to the client;
device configured to provide the second data set from the trusted third party to the client;
device configured to provide the second data set from the client to the server; and
device configured to provide one or more services on the server to the client if the second data set received from the client corresponds to the second data set provided to the trusted third party.

19. The system according to claim 18, wherein the client comprises a computer connectable to the server and a mobile terminal connectable to the trusted third party.

20. The system according to claim 18, wherein the client comprises a mobile terminal connectable to both the server and the trusted third party.

21. The system according to claim 19, wherein the mobile terminal comprises an application program provided by the trusted third party for communicating with the trusted third party and/or the server.

22. The system according to claim 18, wherein the client and the trusted third party are adapted to communicate over an encrypted channel established by an application program provided by the trusted third party.

23. A method for secure log on to a server, comprising:
providing a first user name from a client to the server;
determining if the first user corresponds to a registered user;
providing a second user name and a first password from the client to a trusted third party;
determining if the second user name and first password correspond to a user registered at the trusted third party;
providing a first data set from the server to the trusted third party if the user is registered at the trusted third party;
providing the first data set from the trusted third party to the client;
providing the first data set from the client to the server; and
logging on the client at the server if the second data set received from the client corresponds to the second data set provided to the trusted third party.

24. The method according to claim 23, comprising determining if the first user name and first password correspond to a user registered at the trusted third party.

25. The method according to claim 23, wherein the client comprises a computer connected to the server and a mobile terminal connected to the trusted third party.

26. The method according to claim 23, wherein the client comprises a mobile terminal connected to both the server and the trusted third party.

27. The method according to claim 25, wherein the mobile terminal comprises an application program provided by the trusted third party for communicating with the trusted third party and/or the server.

28. The method according to claim 23, wherein the client and the trusted third party communicates over an encrypted channel established by an application program provided by the trusted third party.

29. The method according to claim 23, wherein in addition to the first user name, a second password is provided from the client to the server and the determination step comprises determining if the first user name and the second password correspond to a user registered at the trusted third party.

30. A system for secure log on to a server, comprising:
a client adapted to provide a first user name to the server;
device configured to determine if the first user name correspond to a registered user;
device configured to provide a second user name and a first password from the client to the trusted third party;
device configured to determine if the second user name and first password correspond to a user registered at a trusted third party;
device configured to provide a first data set from the server to the trusted third party if the user is registered at the trusted third party;
device configured to provide the first data set from the trusted third party to the client;
device configured to provide the first data set from the client to the server; and
device configured to log on the client at the server if the first data set received from the client corresponds to the first data set provided to the trusted third party.

31. The system according to claim 30, comprising device configured to determine if the first user name and first password correspond to a user registered at the trusted third party.

32. The system according to claim 30, wherein the client comprises a computer connectable to the server and a mobile terminal connectable to the trusted third party.

33. The system according to claim 30, wherein the client comprises a mobile terminal connectable to both the server and the trusted third party.

34. The system according to claim 32, wherein the mobile terminal (122) comprises an application program provided by the trusted third party for communicating with the trusted third party and/or the server.

35. The system according to claim 30, wherein the client and the trusted third party are adapted to communicate over an encrypted channel established by an application program provided by the trusted third party.

36. The system according to claim 30, wherein in addition to the first user name, the client is adapted to provide a second password to the server and the device configured to determine is arranged to determine if the first user name and the second password correspond to a user registered at the trusted third party.
